(19) United States
(12) Patent Application Publication
(10) Pub. No.: US 2026/0091732 A1
(43) Pub. Date: Apr. 2, 2026

(54) Self Cleaning Side Step

(71) Applicant: Gen-Y Creations, LLC, Nappanee, IN (US)

(72) Inventor: Carl J. Borkholder, Nappanee, IN (US)

(73) Assignee: Gen-Y Creations, LLC, Nappanee, IN (US)

(21) Appl. No.: 18/899,648

(22) Filed: Sep. 27, 2024

(51) Int. Cl. B60R 3/00

(52) U.S. Cl. CPC B60R 3/002

(57) ABSTRACT

A side step or running board is affixed to a vehicle adjacent to the vehicle entry. The running board has an eggcrate platform that is secured with respect to the vehicle through mounting brackets. The eggcrate platform is formed from a series of stringers and bridge supports that are affixed together to form an array of apertures extending through the platform. Holding brackets are placed into at least two of the apertures and fastened to mounting brackets to secure the platform. The stringers and bridge supports have alternating high and low surfaces to increase traction.

### BACKGROUND OF THE INVENTION

The present disclosure relates to side steps, running boards, and similar structures affixed to the sides of vehicles to allow easier entry and egress. There are two main types of running boards: moveable stowing and fixed. For either type, there is an upper surface that the user steps onto when entering or exiting the vehicle. The upper surface is typically flat and includes anti-skid material, such as textured plastic, rubber or the like. In driving conditions that involve ice, snow, slush, mud, or dirt, these materials can build up on the upper surface. Buildup on the upper surface, in a best-case scenario, causes the user to track dirt and other buildup into the vehicle, or worst-case scenario, the user slips and is injured when stepping onto a slippery upper surface. An improved device is needed.

### SUMMARY OF THE INVENTION

The present disclosure describes a running board/side step for being affixed to a vehicle. The side step has an eggcrate platform, multiple mounting brackets, and multiple holding brackets. The eggcrate platform is formed from bridge supports and stringers that are cut from flat stock and affixed together to form a single structure. The eggcrate platform has a plurality of eggcrate apertures extending therethrough, each eggcrate aperture formed from a first pair of parallel walls that intersect a second pair of parallel walls. The first pair of parallel walls have a top edge and an opposing bottom edge. The top edge has alternating raised and recessed surfaces. The second pair of parallel walls having a top edge and an opposing bottom edge with the top edge having raised and recessed surfaces. The bottom edges are located on a bottom plane and the first and second pairs of parallel walls are perpendicular to the bottom plane.

The side step includes a mounting bracket for affixing to the vehicle chassis and having a landing surface to receive and affix the eggcrate platform. A holding bracket secures the eggcrate platform to the mounting bracket.

### BRIEF DESCRIPTION OF THE DRAWINGS

FIG. 1 is an isometric view of the side step as affixed to a vehicle;

FIG. 2 is a partial isometric exploded view of the side step and vehicle shown in FIG. 1;

FIG. 3 is an isometric view of the side step shown in FIG. 2;

FIG. 4 is an exploded view of the side step shown in FIG. 3;

FIG. 5 is a partial view 5 of the side step shown in FIG. 3;

FIG. 6 is a section view 6-6 of the partial view shown in FIG. 5;

FIG. 7 is an exploded view of the eggcrate platform shown in FIG. 4;

FIG. 8 is a partial view of the exploded view in FIG. 7;

FIG. 9 is an isometric view of a holding bracket shown in FIG. 4;

FIG. 10 is an isometric view of another holding bracket shown in FIG. 4.

### DESCRIPTION OF THE PREFERRED EMBODIMENT

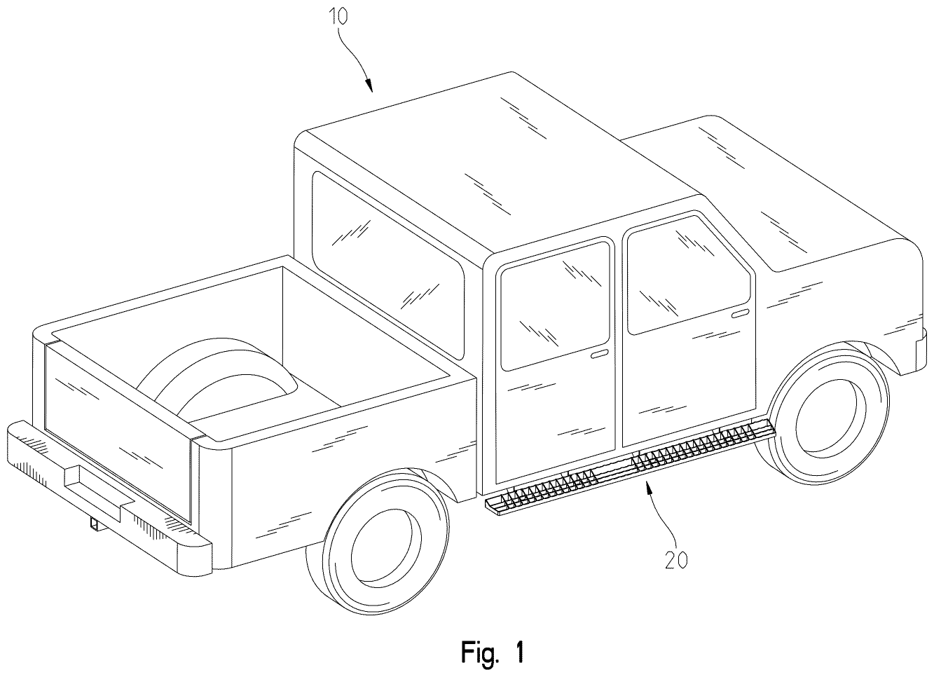

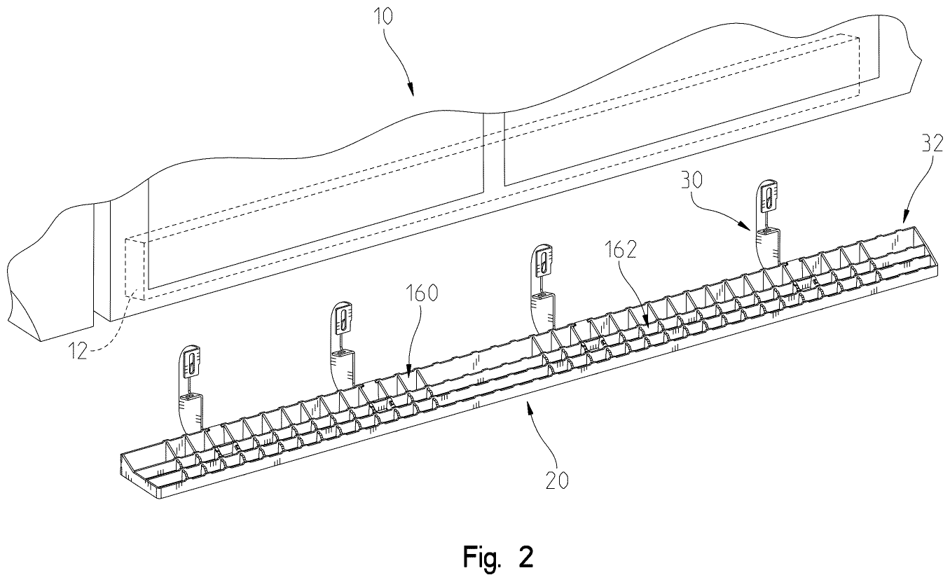

A vehicle 10 having side steps 20 is shown in FIGS. 1 and 2. The side steps 20 are affixed to the chassis 12, frame, or other secure mounting point and are located adjacent the passenger compartment.

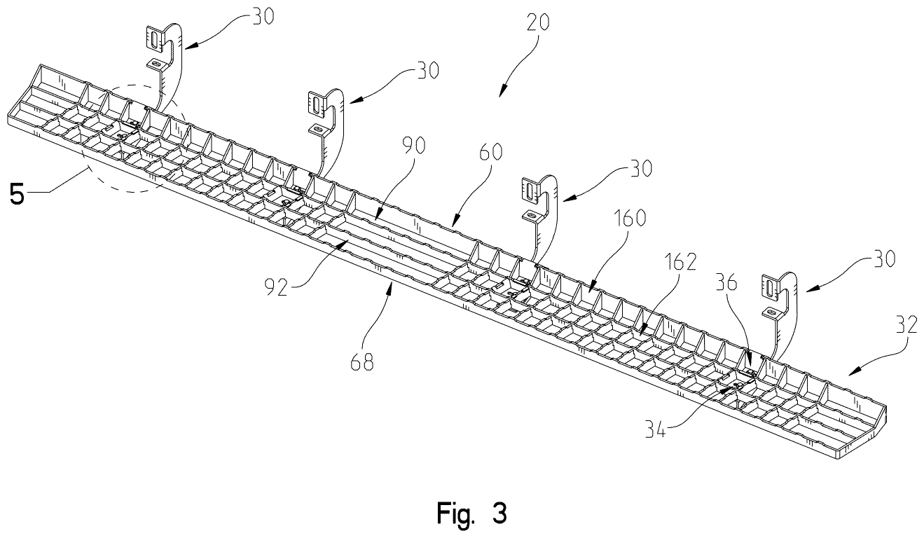

The side steps 20 shown without the vehicle in FIG. 3 are identical to side steps located on the opposite side of the vehicle, except that the features are mirrored. Because of this minor variation between the side steps used on the opposite sides of the vehicle, only one side will be described in detail. Side step 20 has three main components: vehicle mounting brackets 30, an eggcrate platform 32, and platform holding brackets 34, 36 with each main component described in detail below.

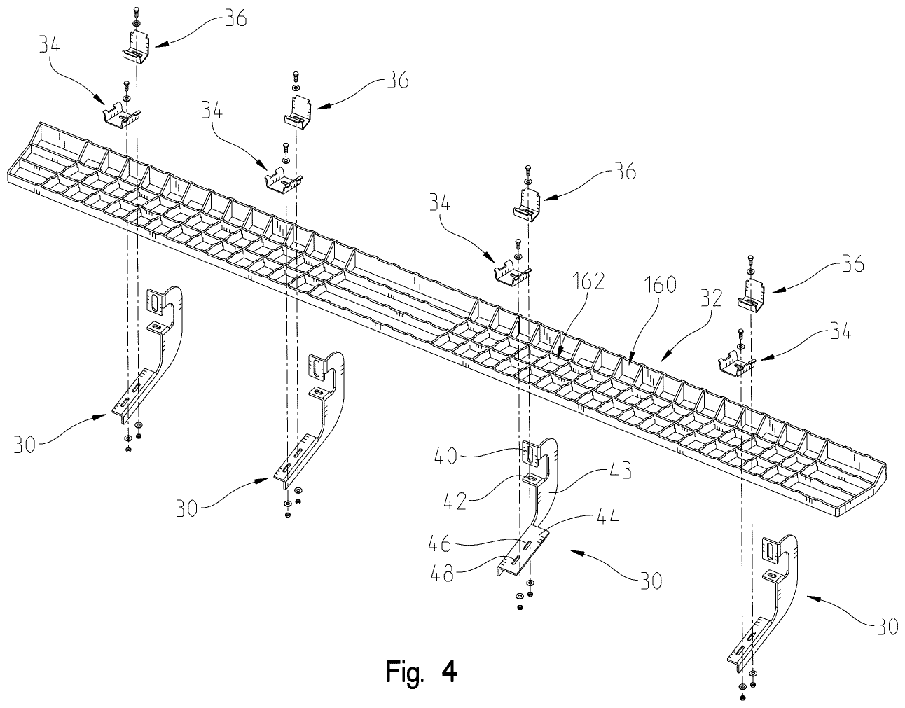

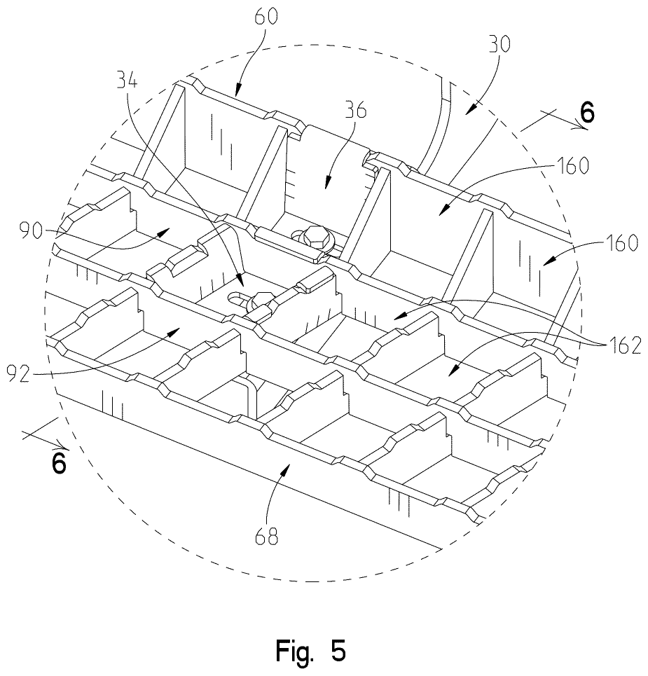

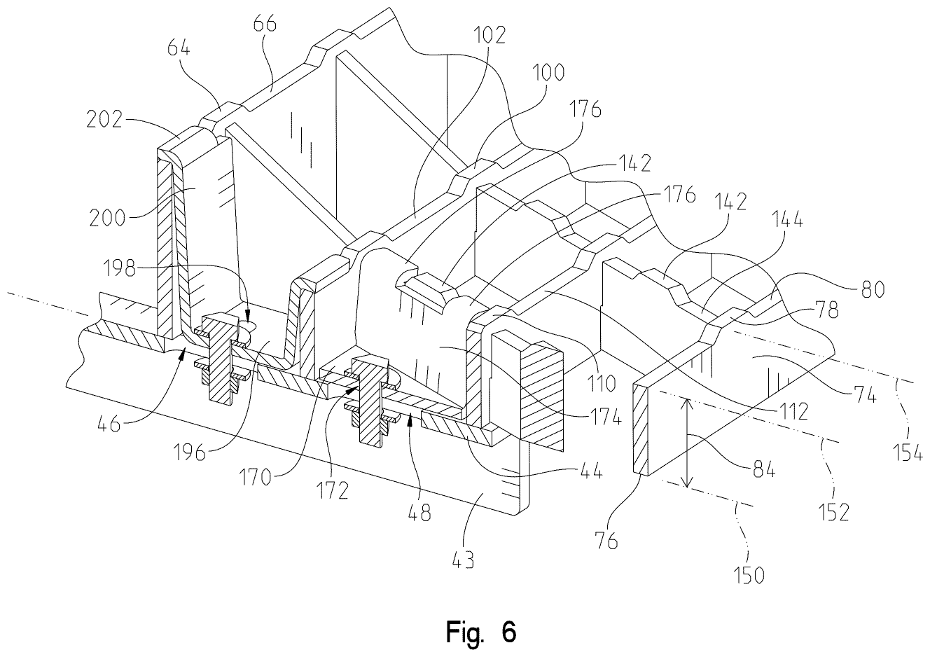

The vehicle mounting bracket 30 has vehicle attachment points 40, 42 where a fastener (not shown) is secured through the attachment point to the vehicle chassis 12. The bracket 30 extends from the attachment points 40, 42 through a flat section 43, to a platform landing surface 44. The landing surface 44 has mounting apertures 46, 48 to receive fasteners. As can be seen in FIG. 4, the brackets 30 may not all be identical to accommodate predetermined mounting points in the chassis 12.

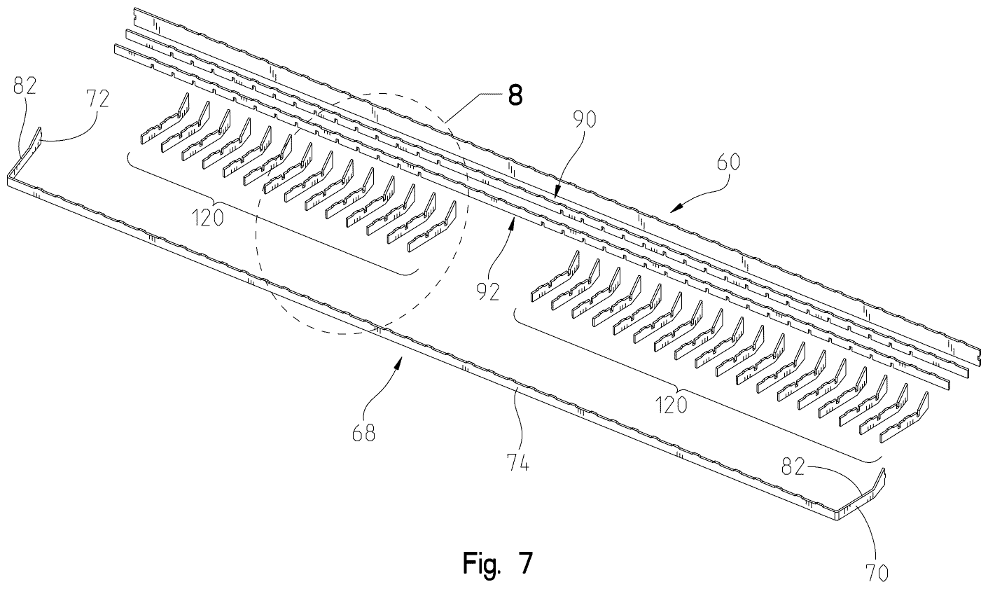

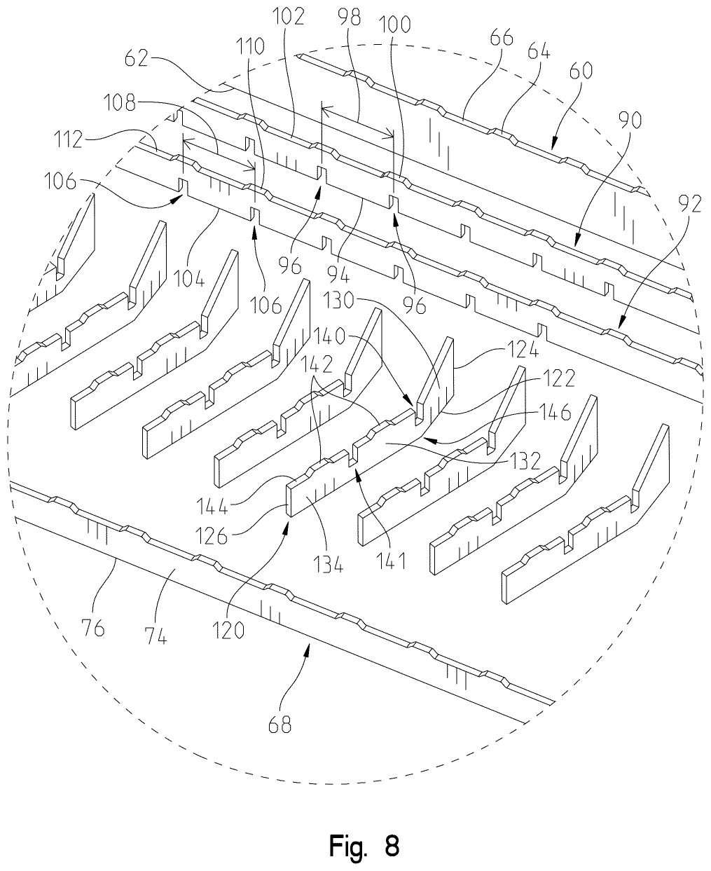

The eggcrate platform 32 is formed from a plurality of parts that are made from sheet metal, cut to predetermined shapes, and secured together vertically to form a rigid structure. An inner stringer 60 extends along the entire length of the platform 32 with a bottom edge 62 and a top edge with alternating raised surfaces 64 and recessed surfaces 66. The distance between the bottom edge 62 and recessed surfaces 66 defines a height with the raised surfaces 64 extending beyond the height. The raised and recessed surfaces 64, 66 are parallel to each other and the bottom edge 62. An outer stringer 68 is a continuous strip with a first end portion 70, a second end portion 72, and a middle portion 74 located therebetween. The end portions 70, 72 are at an angle with respect to the middle portion 74, as shown in FIG. 7. The middle portion 74 has a bottom edge 76 and a top edge with alternating raised surfaces 78 and recessed surfaces 80. The distance between the bottom edge 76 and recessed surfaces 80 defines a height 84 with the raised surfaces 78 extending beyond the height. The raised and recessed surfaces 78, 80 are parallel to each other and the bottom edge 76. As seen in FIG. 7, the end portions 70, 72 are free of undulating raised and recessed surfaces, only a top edge 82 that is in line with the recessed surfaces 80 and parallel to the bottom edge 76. As shown in the FIGS, two intermediate stringers 90, 92 are located between the inner stringer 60 and middle portion 74 of the outer stringer 68. The inner intermediate stringer 90 is parallel to and closest to the inner stringer 60 and the outer intermediate stringer 92 is parallel to the inner intermediate stringer 90 and closest to the middle portion 74. The inner intermediate stringer 90 has a bottom edge 94 that is interrupted with a series of notches 96. The notches 96 are spaced from each other by a notch distance 98. The inner intermediate stringer 90 has a top edge with alternating raised surfaces 100 and recessed surfaces 102 that are parallel to the bottom edge 94. The distance between the bottom edge 94 and recessed surfaces 102 matches the height 84 with the raised surfaces 100 extending beyond the height. As shown, the notches 96 and raised surfaces 100 are aligned so that each notch 96 is located directly below a corresponding raised surface 100. It is contemplated the notches described herein are located elsewhere. The outer intermediate stringer 92 has a bottom edge 104 that is interrupted with a series of notches 106. The notches 106 are spaced from each other by a notch distance 108. The outer intermediate stringer 92 has a top edge with alternating raised surfaces 110 and recessed surfaces 112 that are parallel to the bottom edge 104. The distance between the bottom edge 104 and recessed surfaces 112 matches the height 84 with the raised surfaces 110 extending beyond the height. As shown, the notches 106 and raised surfaces 110 are aligned so that each notch 106 is located below a raised surface 110.

Extending from the inner stringer 60 and the middle portion 74 are a series of bridge supports 120. In the embodiment shown herein, there are thirty-two bridge supports in each eggcrate platform 32 but other amounts are contemplated based on the size or other requirements of the intended vehicle. Each bridge support 120 has a bottom edge 122 that extends uninterrupted between where it intersects an inner edge 124 and an outer edge 126. The inner edge 124 is longer than the outer edge 126. The bridge support 120 is formed from a continuous piece of material but is divided into three regions, a trapezoidal region 130, a center region 132, and an outer region 134. A receiving notch 140 is located where each region meets an adjacent region. The top edge of the trapezoidal region 130 extends from the receiving notch 140 and terminates at a height near the recessed surface 66 on the inner stringer. As shown, the bridge support 120 has two receiving notches 140. The bridge support 120 has a top edge that is interrupted by the receiving notches 140, 141 and has raised surfaces 142 and recessed surfaces 144. A bend 146, adjacent to one of the receiving notches 140, locates the trapezoidal region 130 at an angle with respect to the center and outer regions 132, 134.

The stringers 60, 68, 90, 92 and bridge supports 120 are assembled with the notches 96, 106 being mated to receiving notches 140, 141. The depth of the notches 96, 106 and receiving notches 140, 141 is such that when the stringers 60, 68, 90, 92 and bridge supports 120 are fully mated, the bottom edges 62, 76, 94, 104, 122 are aligned on a bottom plane 150. Except for the inner stringer 60, the recessed surfaces 80, 102, 112, 144 are all located on a first plane 152 and the raised surfaces 78, 100, 110, 142 are on a second plane 154 that is parallel to the first plane 152. The first and second planes 152, 154 are parallel to the bottom plane 150. The intersection of the stringers and bridge supports form an array of eggcrate apertures 160, 162. The eggcrate apertures 160, 162 are unobstructed through the thickness of the eggcrate platform 32. Because of the bend 146, some of the eggcrate apertures are rectangular shaped and others are parallelogram shaped. In any event, each eggcrate aperture 160, 162 has a first set of two parallel walls and a second set of two parallel walls. As shown, all of the stringers and bridge supports are only arranged to be perpendicular to the bottom plane 150.

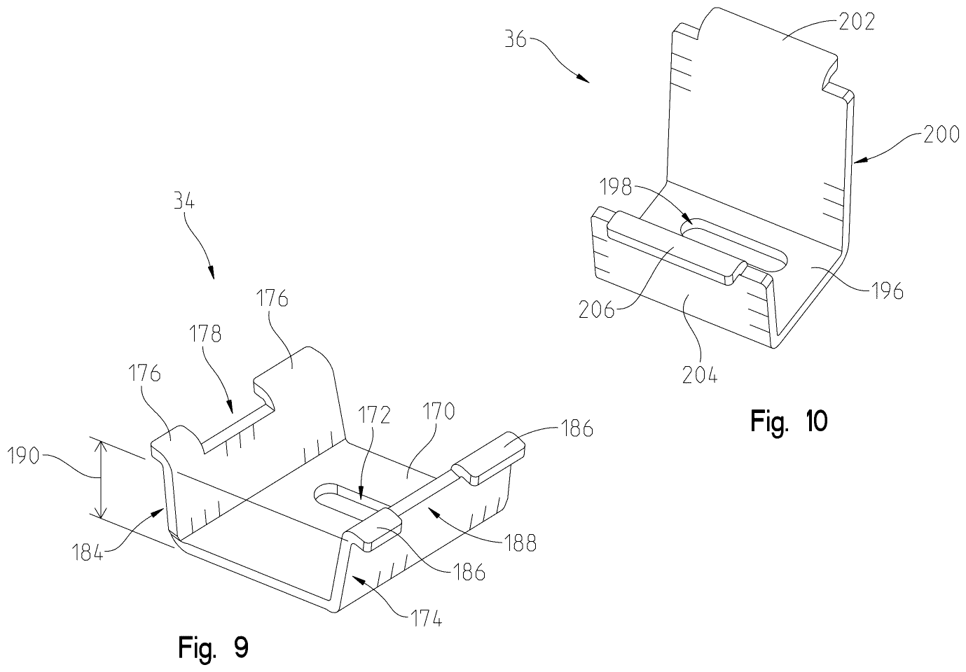

The eggcrate platform 32 is secured to the vehicle mounting brackets 30 with platform holding brackets 34, 36 that reside in eggcrate apertures 160, 162. Specifically, the eggcrate apertures 160, 162 used to attach the eggcrate platform 32 are aligned with mounting apertures 46, 48 on the landing surface 44. Holding bracket 34 resides in one of the eggcrate apertures 162 and holding bracket 36 resides in one of the eggcrate apertures 160. The holding bracket 34 has a fastening portion 170 with an elongate aperture 172. A first upstanding portion 174 extends substantially perpendicular from the fastening portion 170. For clarity, substantially perpendicular is defined as either perpendicular or at a slight but noticeable angle. The first upstanding portion 174 has a hook 176 that is substantially perpendicular to the first upstanding portion 174. As shown in FIG. 9, the hook 176 is not continuous and has a gap 178. The holding bracket 34 has a second upstanding portion 184 that is substantially perpendicular to the fastening portion 170. The second upstanding portion 184 also has a hook 186 and gap 188 that are configured similarly to the first upstanding portion 174. The upstanding portions 174, 184 are spaced apart by a distance and the holding bracket 34 has a length that allows it to be located inside one of the eggcrate apertures 162. As shown, a distance 190 between the bottom surface of the hooks 176, 186 and the bottom surface of the fastening portion 170 is equal to or slightly smaller than the distance between the bottom edge 122 and recessed surface 144 of the bridge supports 120. When properly located inside the eggcrate aperture 162, the hooks 176, 186 secure two bridge supports 120 through biased contact with the recessed surfaces 144. The gaps 178, 188 allow clearance for the raised surfaces 142 of the bridge supports 120, allowing the holding bracket 34 to be installed and secured from the top side of the eggcrate platform 32 without protruding above the raised surfaces 142.

The holding bracket 36 secures the platform 32 through biased contact with stringers that border eggcrate aperture 160. In the embodiment shown herein, the holding bracket 36 interfaces with the inner stringer 60 and inner intermediate stringer 90. A fastening portion 196 has an elongate aperture 198. A first upstanding portion 200 extends substantially perpendicular to the fastening portion 196 and has a hook 202 that is substantially perpendicular to the first upstanding portion 200. A second upstanding portion 204 extends substantially perpendicularly from the fastening portion 196 and located oppositely from the first upstanding portion 200. The second upstanding portion 204 has a hook 206 that is substantially perpendicular to the second upstanding portion 204. The hooks 202, 206 do not extend across the entire width of their corresponding upstanding portion 200, 204, instead being only wide enough to overlay recessed surfaces 66, 102. As can be seen in FIG. 10, the hook 202 on the first upstanding portion 200 is spaced farther from the fastening portion 196 than the hook 206 on the second upstanding portion 204 to account for the height of the inner stringer 60.

As installed, the holding brackets 34, 36 reside substantially inside their respective eggcrate apertures 162, 160. In this context, substantially is defined as most of the holding bracket being located inside the eggcrate aperture. Further, the holding brackets 34, 36 clamp only on the recessed surfaces. In other words, the holding brackets are sufficiently recessed so as not to interfere with the user stepping on the eggcrate platform 32.

The landing surfaces 44 of the mounting brackets 30, as affixed to the vehicle 10, are coplanar to align with the bottom plane 150 when the eggcrate platform 32 is installed. Further, the fasteners that secure the holding brackets 34, 36 are accessible from each side of the side step 20.

The eggcrate platform 32 has a consistent envelope along its length, with the envelope defined by the area between the bottom plane 150 and extending to the second plane 154 and raised surfaces 64 on the inner stringer 60.

To manufacture the eggcrate platform 32, the stringers 60, 68, 90, 92 are first cut from sheet metal stock using lasers, but other cutting methods such as sawing, stamping, or plasma are contemplated. The stringers 60, 90, and 92 do not receive any additional forming but the outer stringer 68 is bent near its ends so that its terminal ends can meet the terminal ends of the inner stringer 60 when assembled. The bridge supports 120 are also cut from sheet metal stock and formed to generate the bend 146, but it is contemplated that the bridge supports 120 are not formed. The features such as notches, raised surfaces, and recessed surfaces are created when the respective part is cut from sheet metal. Next, the bridge supports 120 and stringers 60, 68, 90, 92 are assembled together, mating the notches together and forming the eggcrate apertures 160, 162 and bottom plane 150. Next, the bridge supports 120 are welded or otherwise affixed to the stringers, generating the rigid structure of the eggcrate platform 32. Separately, the vehicle mounting brackets 30 and holding brackets 34, 36 are cut from sheet metal stock and formed using stamping, forming, or equivalent methods. To assemble the side step 20 to the vehicle 10, the user first attaches the vehicle mounting brackets 30 to the chassis 12, locating the landing surfaces 44 all on the same plane. Next, the user positions the eggcrate platform 32 to locate at least one of the eggcrate apertures 160, 162 over the mounting aperture 46 or 48 and places a holding bracket in the corresponding eggcrate aperture. Next, the fastener is placed through the elongate aperture 172, 198 and mounting aperture 46, 48 and tightened. The elongate apertures 172, 198, are elongated in a direction perpendicular to the elongate shape of the mounting apertures 46, 48 to allow for mounting variations. The process is repeated for each vehicle mounting bracket 30.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A side step for attaching to a vehicle, said side step comprising:
a plurality of mounting brackets, each said mounting bracket having a landing surface with a mounting aperture extending therethrough;
an eggcrate platform having:
a plurality of bridge supports, each said bridge support having a bottom edge and a top edge located opposite said bottom edge, said top edge of said bridge supports having alternating raised and recessed surfaces, said bridge supports having a notch on said bottom edge or said top edge;
an intermediate stringer having a bottom edge and a top edge located opposite said bottom edge, said top edge of said intermediate stringer having alternating raised and recessed surfaces, said intermediate stringer having a notch located on said bottom edge or said top edge of said intermediate stringer, said notch on said intermediate stringer mates with said notch on said bridge support to align said bottom edge of said bridge support with said bottom edge;
an inner stringer and an outer stringer affixed to said bridge supports;
said bridge supports affixed between said inner and outer stringers, said intermediate stringer affixed to said bridge supports; and
a plurality of eggcrate apertures located between said bridge supports and said stringers, said eggcrate apertures extending through said eggcrate platform;
a holding bracket for being located in one of said eggcrate apertures to affix said eggcrate platform to said mounting bracket, said holding bracket having a fastening portion and an upstanding portion extending therefrom, said upstanding portion having a hook for clamping a portion of one of said recessed surfaces when said holding bracket is secured to said mounting bracket.

2. The side step of claim 1, wherein said notches in said bridge support interrupt said recessed surfaces, at least one of said raised surfaces is located between a first of said notches and a second of said notches, said notches in said intermediate stringer interrupts said bottom edge.

3. The side step of claim 1, wherein said outer stringer having a first end portion and an oppositely located second end portion, said outer stringer is free of notches.

4. The side step of claim 1, further comprising a bottom plane aligned with said bottom edges, an upper plane aligned with said raised surfaces of said bridge supports and said intermediate stringer, and a lower plane aligned with said recessed surfaces of said bridge supports and said intermediate stringer, said inner stringer having a continuous bottom edge located on said bottom plane, said inner stringer having raised and recessed surfaces, said upper and lower planes located between said recessed surfaces of said inner stringer and said bottom plane.

5. The side step of claim 4, wherein said bridge supports have a trapezoid region that extends from one of said notches and terminates at an inner edge, said inner edge abuts said inner stringer, said trapezoid region is at an oblique angle with respect to said bridge support.

6. The side step of claim 4, wherein each said eggcrate apertures have a first set of opposing parallel walls and a second set of opposing parallel walls, said first and second sets of parallel walls are perpendicular to said bottom plane.

7. The side step of claim 1, wherein each said bridge support has a portion that is at an oblique angle.

8. The side step of claim 1, wherein each said eggcrate apertures has a first pair of two parallel walls, said first pair of parallel walls are perpendicular to a bottom plane formed by said bottom edges on said bridge supports and said intermediate stringer.

9. The side step of claim 1, wherein said raised surfaces of said bridge supports are spaced from said raised surfaces of said stringers.

10. The side step of claim 1, wherein said landing surfaces of said mounting brackets are located on a bottom plane when said eggcrate platform is affixed thereto.

11. A side step for being affixed to a vehicle, said side step comprising:
an eggcrate platform having a plurality of eggcrate apertures extending therethrough, each said eggcrate aperture formed from a first pair of parallel walls intersecting and fixed with respect to a second pair of parallel walls, said first pair of parallel walls each having a top edge and an opposing bottom edge, said top edge of said first pair of parallel walls each having a raised and recessed surface, said second pair of parallel walls each having a top edge and an opposing bottom edge, said top edge of said second pair of parallel walls each having a raised and recessed surface, said bottom edges of said first and second pairs of parallel walls located on a bottom plane, said first and second pairs of parallel walls are perpendicular to said bottom plane;
a mounting bracket having a landing surface; and
a holding bracket for contacting at least one of said recessed surfaces to affix said eggcrate platform to said landing surface.

12. The side step of claim 11, wherein one of said first pair of parallel walls is located on a bridge support, said bridge support having a notch on said bottom edge or said top edge.

13. The side step of claim 12, wherein one of said second pair of parallel walls is located on an intermediate stringer, said intermediate stringer having a notch on said bottom edge or said top edge, said notch on said stringer is mated to said notch on said bridge support.

14. The side step of claim 12, wherein said eggcrate platform has an inner stringer and an outer stringer affixed to said bridge supports.

15. The side step of claim 12, wherein said bridge supports have a trapezoid region that extends from one of said notches and terminates at an inner edge, said inner edge abuts an inner stringer, said trapezoid region is at an oblique angle with respect to said bridge support.

16. The side step of claim 11, wherein said holding bracket is substantially located in one of said eggcrate apertures.

17. The side step of claim 16, wherein said holding bracket having a fastening portion and an upstanding portion extending therefrom, said upstanding portion having a hook for clamping a portion of one of said recessed surfaces when said holding bracket is secured to said mounting bracket.

18. A method of manufacturing a side step comprising:
cutting sheet metal into a plurality of bridge supports, each said bridge support having a top edge and a bottom edge opposite thereto, said top edge having alternating raised and recessed surfaces, said bridge support having notches in said top edge or said bottom edge;
cutting said sheet metal into a plurality of stringers, one of said stringers is an intermediate stringer with a top edge and a bottom edge opposite thereto, said top edge having alternating raised and recessed surfaces, said intermediate stringer having notches in said top edge or said bottom edge, a second of said stringers is an inner stringer, a third of said stringers is an outer stringer, said outer stringer having a first end portion and a second end portion, bending said end portions with respect to a middle portion of said outer stringer;
assembling said bridge supports to intersect said stringers and mating said notches of said bridge supports to said notches of said intermediate stringer;
affixing said bridge supports to said stringers; and
affixing said end portions of said outer stringer to said inner stringer.

19. The method of claim 18, wherein said cutting is performed using a laser and said affixing is performed using a welder.

20. The method of claim 18, further comprising the step of bending said bridge support to be at an oblique angle.
